(19) United States
(12) Patent Application Publication
(10) Pub. No.: US 2026/0149220 A1
(43) Pub. Date: May 28, 2026

(54) CONNECTOR

(71) Applicant: SUMITOMO WIRING SYSTEMS, LTD., Mie (JP)

(72) Inventor: Junya ITO, Mie (JP)

(21) Appl. No.: 19/395,361

(22) Filed: Nov. 20, 2025

(30) Foreign Application Priority Data
Nov. 22, 2024 (JP) 2024-203941

(51) Int. Cl. H01R 13/52; H01R 13/405

(52) U.S. Cl. CPC H01R 13/521; H01R 13/405; H01R 2201/26

(57) ABSTRACT

A connector includes a terminal and a housing made of synthetic resin and integrally formed with the terminal by insert molding. The housing includes a terminal holding portion for holding the terminal. The terminal includes a plate-like embedded portion to be embedded inside the terminal holding portion. The embedded portion has a first principal surface and a second principal surface located at positions facing each other in a plate thickness direction. A plurality of engaging recesses are provided in at least one of the first and second principal surfaces.

### CROSS-REFERENCE TO RELATED APPLICATIONS

This application is based on and claims priority from Japanese Patent Application No. 2024-203941, filed on Nov. 22, 2024, with the Japan Patent Office, the disclosure of which is incorporated herein in its entirety by reference.

### TECHNICAL FIELD

The present invention relates to a connector.

### BACKGROUND

Conventionally, a connector is known which is provided with a housing made of synthetic resin and integrally formed with a terminal by insert molding (see, for example, Japanese Patent Laid-open Publication No. 2014-135131). The housing is provided with a terminal holding portion for holding the terminal. The terminal is provided with an embedded portion to be embedded inside the terminal holding portion and a connecting portion extending to the outside of the terminal holding portion. A terminal of a mating connector connected to the housing is connected to the connecting portion of the terminal.

### SUMMARY

In the connector as described above, how to suppress the intrusion of liquids such as water and oil between the synthetic resin forming the housing and the terminal is a problem.

The present disclosure aims to provide a connector enabling an improvement in waterproofness.

The present disclosure is directed to a connector with a terminal and a housing made of synthetic resin, the housing being integrally formed with the terminal by insert molding, the housing including a terminal holding portion for holding the terminal, the terminal including a plate-like embedded portion to be embedded inside the terminal holding portion, the embedded portion having a first principal surface and a second principal surface located at positions facing each other in a plate thickness direction, and a plurality of engaging recesses being provided in at least one of the first and second principal surfaces.

According to the connector of the present disclosure, waterproofness can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of one embodiment.

FIG. 2 is a front view of the connector of the embodiment.

FIG. 3 is a section along 3-3 in FIG. 2.

FIG. 4 is an enlarged section showing a part of FIG. 3.

FIG. 5 is a section along 5-5 in FIG. 4.

FIG. 6 is an enlarged section enlargedly showing a part of FIG. 5.

FIG. 7 is an enlarged section showing a part of a connector of a modification.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The connector of the present disclosure is provided with a terminal and a housing made of synthetic resin, the housing being integrally formed with the terminal by insert molding, the housing including a terminal holding portion for holding the terminal, the terminal including a plate-like embedded portion to be embedded inside the terminal holding portion, the embedded portion having a first principal surface and a second principal surface located at positions facing each other in a plate thickness direction, and a plurality of engaging recesses being provided in at least one of the first and second principal surfaces.
According to this configuration, adhesion between the terminal and the synthetic resin forming the housing is improved by a so-called anchoring effect by the entrance of the synthetic resin forming the housing into each of the plurality of engaging recesses provided in the embedded portion of the terminal. Therefore, the waterproofness of the connector can be improved.
[2] In [1] described above, the terminal may project outwardly of the terminal holding portion from an end surface of the terminal holding portion, a projecting portion surrounding the terminal may be provided on the end surface in the housing, and the plurality of engaging recesses may include an end side engaging recess provided inside the projecting portion.
According to this configuration, the waterproofness of the connector can be suitably improved by the entrance of the synthetic resin forming the housing into the end side engaging recess provided in the embedded portion.
[3] In [2] described above, the terminal holding portion may have the end surface including the projecting portion on each of both sides in a length direction of the embedded portion, the end side engaging recess may be provided inside each of a pair of the projecting portions, and the plurality of engaging recesses may include an intermediate engaging recess provided between the end side engaging recess provided inside one of the pair of projecting portions and the end side engaging recess provided inside the other of the pair of projecting portions in the embedded portion.
According to this configuration, since the plurality of engaging recesses (end side engaging recesses and intermediate engaging recess) are provided in a wide range in the length direction of the embedded portion, the waterproofness of the connector can be even more improved.
[4] In any one of [1] to [3] described above, the embedded portion may include an end edge recess in an end edge in a width direction of the embedded portion.
According to this configuration, adhesion between the terminal and the synthetic resin forming the housing is improved by the so-called anchoring effect by the entrance of the synthetic resin forming the housing into the end edge recess provided in the embedded portion of the terminal. Therefore, the waterproofness of the connector can be even more improved.
[5] In [4] described above, the embedded portion may include a non-forming region where the engaging recesses are not formed in an entire range occupied by the end edge recess in a length direction of the embedded portion.
According to this configuration, since the engaging recesses are not formed in the entire range occupied by the end edge recess in the length direction of the embedded portion, a reduction in a cross-sectional area orthogonal to the length direction in the embedded portion can be suppressed.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. “Parallel”, and “perpendicular (orthogonal)” in this specification mean not only strictly parallel and perpendicular (orthogonal), but also substantially parallel and perpendicular (orthogonal) within a range in which functions and effects in an embodiment are achieved.

A term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape. “Tubular” outer peripheral shapes include circular shapes, elliptical shapes and polygonal shapes with angular or rounded corners, but there is no limitation to these. A “tubular” shape is a shape including a through hole in a plan view, and an outer peripheral shape and an inner peripheral shape of the through hole may be the same or different. The “tubular” shape may have a predetermined length along an axial direction, in which a center axis passing through a center of the through hole extends, and that length does not matter. Further, terms such as “first” and “second” in this specification are merely used to distinguish objects and do not rank the objects. The present invention is not limited to these illustrations, but is represented by claims and intended to include all changes in the scope of claims and in the meaning and scope of equivalents.

### Configuration of Connector 10

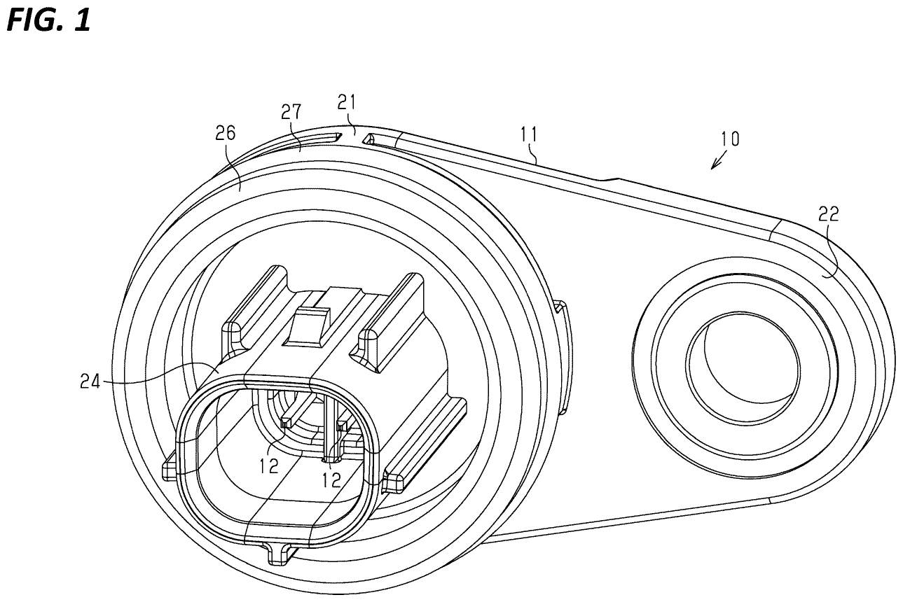

A connector 10 shown in FIG. 1 is, for example, mounted on a device case installed in a vehicle. The connector 10 is, for example, a relay connector for electrically connecting the inside and outside of the device case. Further, the connector 10 is a waterproof connector. The connector 10 is fixed to the device case by an unillustrated bolt. A transmission case, the inside of which is an oil environment, can be cited as an example of the device case on which the connector 10 is to be mounted.

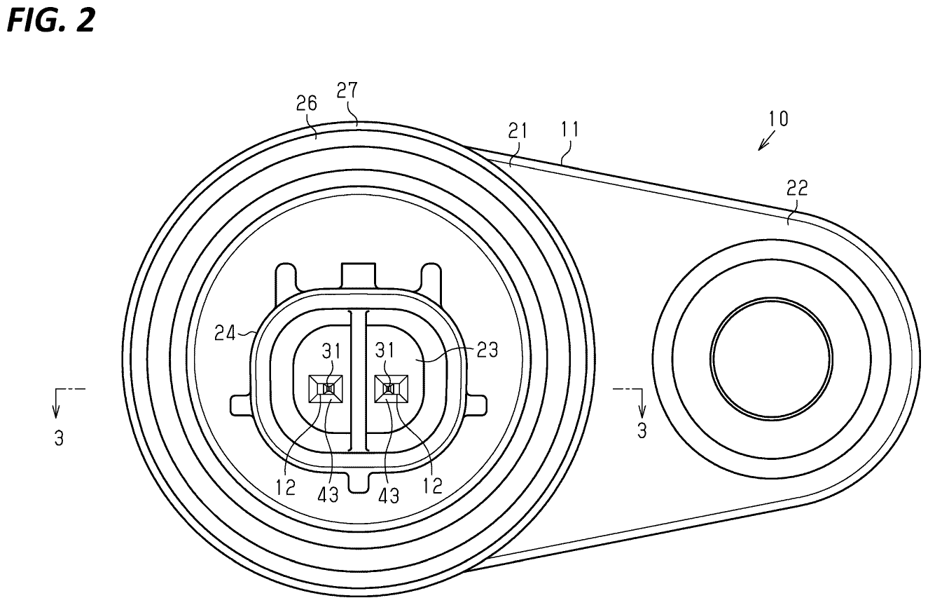

As shown in FIGS. 1 and 2, the connector 10 is provided with a housing 11 and, for example, two terminals 12. The housing 11 is made of synthetic resin. Each terminal 12 is made of a metal material. The housing 11 is integrally formed with the respective terminals 12 by insert molding.

### Configuration of Housing 11

The housing 11 is provided with a body portion 21 and a fixing portion 22 extending from the body portion 21. The fixing portion 22 is, for example, fixed to the device case by the unillustrated bolt.

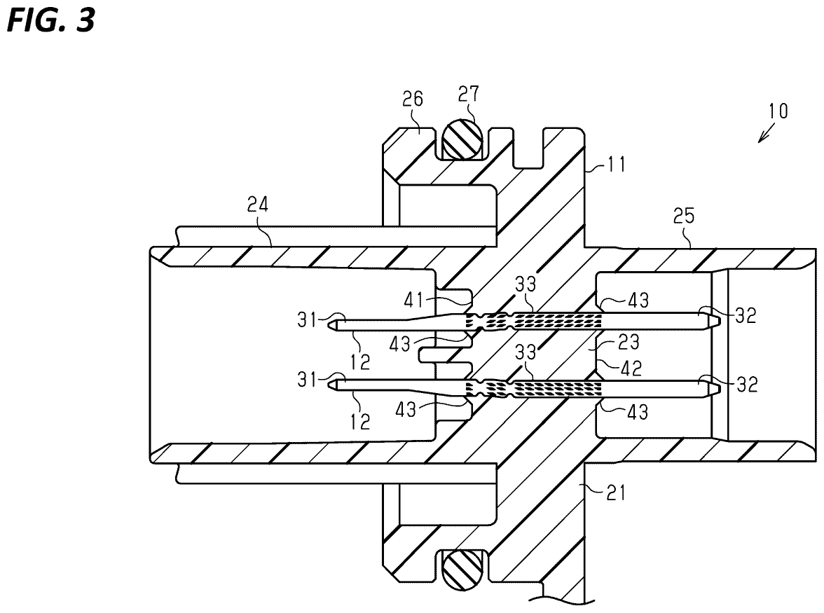

As shown in FIG. 3, the body portion 21 of the housing 11 includes a terminal holding portion 23 for holding the respective terminals 12. Note that only the respective terminals 12 are not shown in section in FIG. 3. The housing 11 includes a first fitting portion 24 and a second fitting portion 25 respectively extending from the terminal holding portion 23. Each of the first and second fitting portions 24, 25 has a tubular shape. The first and second fitting portions 24, 25 extend from the terminal holding portion 23, for example, in directions opposite to each other. An unillustrated internal connector in the device case is connected to the first fitting portion 24, and an unillustrated external connector is connected to the second fitting portion 25. That is, if the connector 10 is, for example, mounted on the transmission case, the first fitting portion 24 is arranged in the oil environment in the device case and the second fitting portion 25 is arranged in an air environment outside the device case.

The housing 11 includes a tubular inserting tube portion 26 extending from the body portion 21. The inserting tube portion 26 extends from the body portion 21 to surround the outer periphery of the first fitting portion 24. A ring-shaped sealing member 27 is provided on the outer periphery of the inserting tube portion 26. The inserting tube portion 26 is inserted into an opening of the device case and sealing is provided between this opening and the inserting tube portion 26 by the sealing member 27.

### Configuration of Terminal 12

Each terminal 12 has, for example, an elongated shape extending substantially straight in one direction. The terminal 12 includes a first connecting portion 31 and a second connecting portion 32 in both end parts in a length direction of the terminal 12. The terminal holding portion 23 in the housing 11 has a first end surface 41, which is one end surface in the length direction of the terminal 12, and a second end surface 42, which is the other end surface in the length direction of the terminal 12. The first connecting portion 31 projects outwardly of the terminal holding portion 23 from the first end surface 41. The first connecting portion 31 is located inside the first fitting portion 24 and connected to a mating terminal of the internal connector. The second connecting portion 32 projects outwardly of the terminal holding portion 23 from the second end surface 42. The second connecting portion 32 is located inside the second fitting portion 25 and connected to a mating terminal of the external connector.

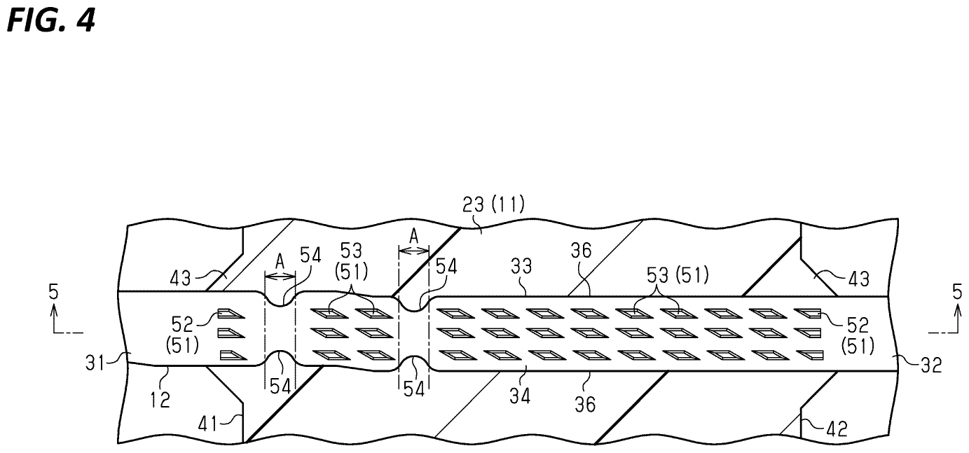

As shown in FIGS. 3 and 4, projecting portions 43 surrounding the respective terminals 12 are provided on each of the first and second end surfaces 41, 42 in the terminal holding portion 23. The respective projecting portions 43 project along projecting directions of the terminals 12 from the first and second end surfaces 41, 42. The projecting portion 43 is, for example, shaped based on the shape of a guiding portion of a mold used in disposing the terminal 12 in the mold during the insert molding of the housing 11. That is, the projecting portion 43 is shaped to be tapered in the projecting direction of the terminal 12.

### Configuration of Embedded Portion 33

Each terminal 12 includes a plate-like embedded portion 33 embedded inside the terminal holding portion 23. The embedded portion 33 is a part of the terminal 12 to be embedded between the first and second end surfaces 41, 42 in the terminal holding portion 23. The embedded portion 33 is provided between the first and second connecting portions 31, 32.

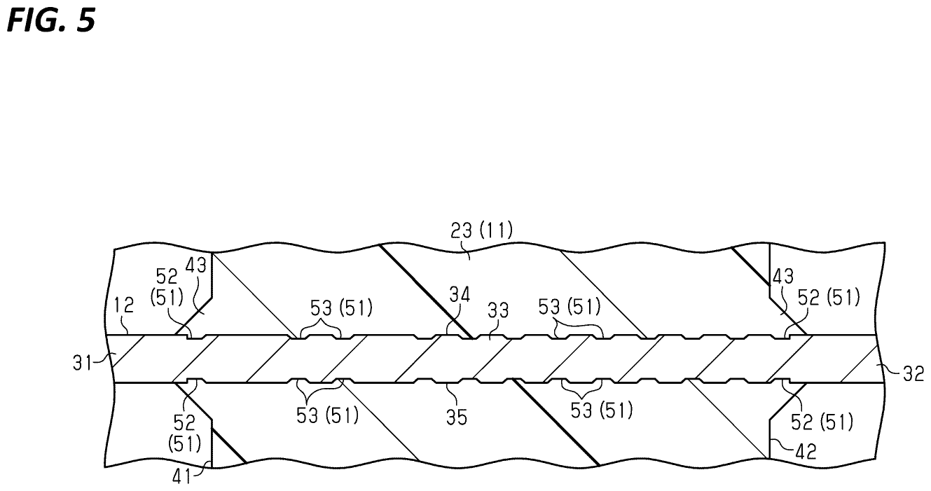

As shown in FIG. 5, the embedded portion 33 of the terminal 12 has a first principal surface 34 and a second principal surface 35, which are both side surfaces in a plate thickness direction of the embedded portion 33. The first and second principal surfaces 34, 35 are at positions facing each other in the plate thickness direction. The first and second principal surfaces 34, 35 are, for example, parallel to each other.

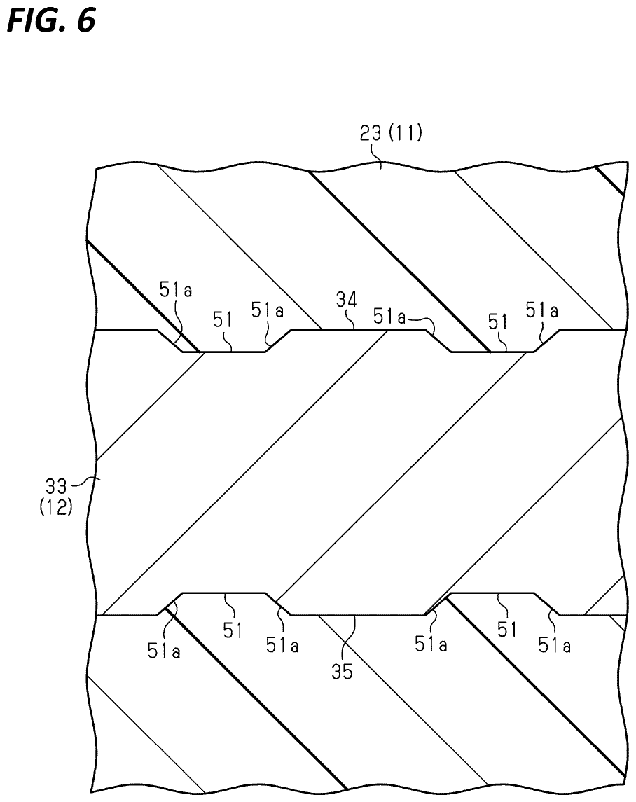

A plurality of engaging recesses 51 are provided in each of the first and second principal surfaces 34, 35 in the terminal 12. In this embodiment, three rows of the engaging recesses 51 arranged along the length direction are provided in a width direction in each of the first and second principal surfaces 34, 35 (see FIG. 4). Further, regions where the engaging recesses 51 are not formed are set in predetermined ranges in the width direction from end edges 36 on both sides in the width direction of the embedded portion 33. The engaging recesses 51 in the first principal surface 34 and the engaging recesses 51 in the second principal surface 35 are, for example, provided at positions overlapping each other in the plate thickness direction. As shown in FIG. 6, side surfaces 51a of each engaging recess 51 are inclined surfaces inclined with respect to the first and second principal surfaces 34, 35.

As shown in FIGS. 4 and 5, in the terminal 12 of this embodiment, the plurality of engaging recesses 51 include a plurality of end side engaging recesses 52 and a plurality of intermediate engaging recesses 53 in each of the first and second principal surfaces 34, 35.

The end side engaging recesses 52 are provided inside the projecting portions 43. That is, the end side engaging recesses 52 are provided in parts located inside the projecting portions 43 in the embedded portion 33. Note that the end side engaging recesses 52 may be at least partially provided inside the projecting portions 43.

The intermediate engaging recesses 53 are provided between the end side engaging recesses 52 respectively located on both ends in a length direction of the embedded portion 33. That is, the intermediate engaging recesses 53 are provided between the end side engaging recesses 52 provided inside the projecting portion 43 on the first end surface 41 and the end side engaging recesses 52 provided inside the projecting portion 43 on the second end surface 42.

As shown in FIG. 4, the embedded portion 33 is provided with end edge recesses 54 in the end edges 36 in the width direction of the embedded portion 33. The end edge recesses 54 are recessed inward in the width direction from the end edges 36 of the embedded portion 33. The end edge recesses 54 are, for example, provided in each of the end edges 36 on the both sides in the width direction of the embedded portion 33. The end edge recesses 54 respectively provided in the end edges 36 on the both sides in the width direction of the embedded portion 33 are, for example, provided at positions overlapping in the width direction of the embedded portion 33.

The embedded portion 33 includes non-forming regions A where the engaging recesses 51 are not formed in entire ranges occupied by the end edge recesses 54 in the length direction of the embedded portion 33. That is, the end edge recesses 54 and the engaging recesses 51 are provided at positions not overlapping each other in the width direction of the embedded portion 33.

### Functions of Embodiment

Functions of this embodiment are described below.

By forming the housing 11 with the terminals 12 as inserts by insert molding, the synthetic resin forming the housing 11 enters the respective engaging recesses 51 and the respective end edge recesses 54 in the embedded portion 33 of the terminal 12. In this way, adhesion between the embedded portion 33 and the terminal holding portion 23 of the housing 11 is improved by a so-called anchoring effect. As a result, the intrusion of liquids such as water and oil between the embedded portion 33 and the terminal holding portion 23 of the housing 11 can be prevented. In this way, it is, for example, possible to save time and effort for filling a potting material for preventing the intrusion of water and oil to the first and second end surfaces 41, 42 of the terminal holding portion 23. Further, by making the use of the potting material unnecessary, a space for filling the potting material can be omitted. This can contribute to the size reduction of the housing 11. Further, a position shift of the embedded portion 33 in the length direction can also be suppressed by the entrance of the synthetic resin forming the housing 11 into the respective engaging recesses 51 and the respective end edge recesses 54 of the embedded portion 33.

### Effects of Embodiment

Effects of the embodiment are described below.
(1) The plurality of engaging recesses 51 are provided in each of the first and second principal surfaces 34, 35 in the embedded portion 33 of the terminal 12. According to this configuration, the synthetic resin forming the housing 11 enters each of the plurality of engaging recesses 51 provided in the embedded portion 33 of the terminal 12, whereby adhesion between the terminal 12 and the synthetic resin forming the housing 11 is improved by the so-called anchoring effect. Therefore, the waterproofness of the connector 10 can be improved.
(2) The terminal 12 projects outwardly of the terminal holding portion 23 from each of the first and second end surfaces 41, 42 of the terminal holding portion 23. The projecting portions 43 surrounding the terminals 12 are provided on each of the first and second end surfaces 41, 42 in the housing 11. The plurality of engaging recesses 51 include the end side engaging recesses 52 provided inside the projecting portions 43. According to this configuration, the waterproofness of the connector 10 can be suitably improved by the entrance of the synthetic resin forming the housing 11 into the end side engaging recesses 52 provided in the embedded portion 33.
(3) The terminal holding portion 23 has the end surfaces (first and second end surfaces 41, 42) including the projecting portions 43 on the both sides in the length direction of the embedded portion 33. The end side engaging recesses 52 are provided inside a pair of the projecting portions 43 (i.e. the projecting portion 43 on the first end surface 41 and the projecting portion 43 on the second end surface 42) on the both sides in the length direction of the embedded portion 33. The plurality of engaging recesses 51 include the intermediate engaging recesses 53 provided between the end side engaging recesses 52 provided inside the projecting portion 43 on the first end surface 41 and the end side engaging recesses 52 provided inside the projecting portion 43 on the second end surface 42. According to this configuration, since the plurality of engaging recesses 51 (end side engaging recesses 52 and intermediate engaging recesses 53) are provided in a wide range in the length direction of the embedded portion 33, the waterproofness of the connector 10 can be even more improved.
(4) The embedded portion 33 includes the end edge recesses 54 in the end edges 36 in the width direction of the embedded portion 33. According to this configuration, adhesion between the terminal 12 and the synthetic resin forming the housing 11 is improved by the so-called anchoring effect by the entrance of the synthetic resin forming the housing 11 into the end edge recesses 54 provided in the embedded portion 33 of the terminal 12. Therefore, the waterproofness of the connector 10 can be even more improved.
(5) The embedded portion 33 includes the non-forming regions A where the engaging recesses 51 are not formed in the entire ranges occupied by the end edge recesses 54 in the length direction of the embedded portion 33. According to this configuration, the engaging recesses 51 are not formed in the entire ranges occupied by the end edge recesses 54 in the length direction of the embedded portion 33. That is, the end edge recesses 54 and the engaging recesses 51 are provided at the positions not overlapping each other in the width direction of the embedded portion 33. Thus, a reduction in a cross-sectional area orthogonal to the length direction in the embedded portion 33 can be suppressed.

### Other Embodiments

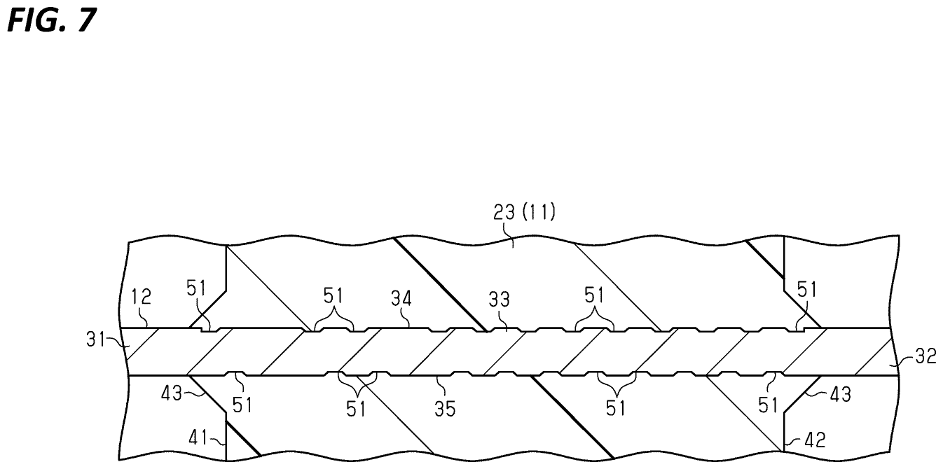

The above embodiment can be modified and carried out as follows. The above embodiment and the following modifications can be combined with each other without technically contradicting.
As shown in FIG. 7, in the embedded portion 33 of the terminal 12, the engaging recesses 51 in the first principal surface 34 and the engaging recesses 51 in the second principal surface 35 may be provided at positions not overlapping each other in the plate thickness direction of the embedded portion 33. In an example shown in FIG. 7, the engaging recesses 51 in the first principal surface 34 and the engaging recesses 51 in the second principal surface 35 are provided at positions shifted from each other in the length direction of the embedded portion 33. According to this configuration, a reduction in the cross-sectional area orthogonal to the length direction in the embedded portion 33 can be suppressed.
The configuration of the engaging recesses 51 such as the shape and the arrangement is not limited to that of the above embodiment and can be changed as appropriate according to the configuration of the connector 10.
The side surfaces 51a of the engaging recess 51 may be flat surfaces perpendicular to the first and second principal surfaces 34, 35.
The numbers of the end side engaging recesses 52 and the intermediate engaging recesses 53 included in the plurality of engaging recesses 51 are not limited to those of the above embodiment and can be changed as appropriate according to the configuration of the connector 10.
The engaging recesses 51 may be provided in only either one of the first and second principal surfaces 34, 35.
The respective end side engaging recesses 52 may be omitted from the engaging recesses 51 in the above embodiment. Further, the respective intermediate engaging recesses 53 may be omitted from the engaging recesses 51 in the above embodiment.
In the terminal 12, the end edge recesses 54 respectively provided in the end edges 36 on the both sides in the width direction of the embedded portion 33 may be provided at positions not overlapping in the width direction of the embedded portion 33. That is, the end edge recesses 54 respectively provided in the end edges 36 on the both sides in the width direction of the embedded portion 33 may be provided at positions shifted from each other in the length direction of the embedded portion 33.
The configuration of the terminals 12 such as the number and the arrangement is not limited to that of the above embodiment and can be changed as appropriate according to the configuration of the connector 10.
The embodiment disclosed this time is illustrated in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal; and
a housing made of synthetic resin, the housing being integrally formed with the terminal by insert molding,
the housing including a terminal holding portion for holding the terminal,
the terminal including a plate-like embedded portion to be embedded inside the terminal holding portion,
the embedded portion having a first principal surface and a second principal surface located at positions facing each other in a plate thickness direction, and
a plurality of engaging recesses being provided in at least one of the first and second principal surfaces.

2. The connector of claim 1, wherein:
the terminal projects outwardly of the terminal holding portion from an end surface of the terminal holding portion,
a projecting portion surrounding the terminal is provided on the end surface in the housing, and
the plurality of engaging recesses include an end side engaging recess provided inside the projecting portion.

3. The connector of claim 2, wherein:
the terminal holding portion has the end surface including the projecting portion on each of both sides in a length direction of the embedded portion,
the end side engaging recess is provided inside each of a pair of the projecting portions, and
the plurality of engaging recesses include an intermediate engaging recess provided between the end side engaging recess provided inside one of the pair of projecting portions and the end side engaging recess provided inside the other of the pair of projecting portions in the embedded portion.

4. The connector of claim 1, wherein the embedded portion includes an end edge recess in an end edge in a width direction of the embedded portion.

5. The connector of claim 4, wherein the embedded portion includes a non-forming region where the engaging recesses are not formed in an entire range occupied by the end edge recess in a length direction of the embedded portion.
